(19) United States
(12) Patent Application Publication
(10) Pub. No.: US 2001/0046712 A1
(43) Pub. Date: Nov. 29, 2001

(54) Fluorescence imaging of biological media on a rotating stage

(75) Inventors: Zhijiang Hang, Burlington, MA (US); Victor Lazarev, Lexington, MA (US); Jin Qian, Stoneham, MA (US)

Correspondence Address: THOMAS P O'CONNELL, 135 CAMBRIDGE STREET SUITE 10, BURLINGTON, MA, 01803

(73) Assignee: New Dimiension Research & Instrument, Inc.

(21) Appl. No.: 09/798,823

(22) Filed: Mar. 1, 2001

Related U.S. Application Data
(60) Provisional application No. 60/186,124, filed on Mar. 1, 2000.

(51) Int. Cl. G01N 21/64

(52) U.S. Cl. 436/172; 422/82.08

(57) ABSTRACT

A fluorescence optical pickup unit (FOPU) for reading fluorescence images of biological media from solid substrates on a rotating stage. The FOPU can comprise a semiconductor laser as an excitation source, a mini-scanner to distribute the excitation light over the media, a color optical fiber as a filter, and a photodetector for detecting fluorescence. The FOPU can be miniaturized through the incorporation of a laser/detector array.

### FIELD OF THE INVENTION

This invention relates generally to systems and methods for the fluorescence imaging of biological media on solid substrates. In particular, the invention disclosed and protected by this patent represents an improvement in the design and performance of biochip readers by the provision of a fluorescence optical pickup unit (FOPU) that induces and collects fluorescence. More specifically, the invention enables fluorescence imaging of biological media by use of a rotating stage, and the invention miniaturizes the FOPU through the incorporation of a laser/detector array and a mini-scanner.

### BACKGROUND OF THE INVENTION

New ways to decipher and use genetic information are a landmark of modern medicine. It has become a staple for diagnosis, monitoring and treatment of cancer, tuberculosis, hepatitis, HIV, and many other diseases. With the entire human genome already mapped out, biochip technology is beginning to enable researchers and clinicians to analyze large amounts of genetic information more rapidly and efficiently than ever before. The application of biochips is rapidly making a transition from scientific laboratories to clinical settings and field use. Physicians, pharmacologists, and research scientists are finding new applications of DNA analysis in their lines of work.

While conventional clinical testing is limited in processing speed and efficiency, biochips provide fast and reliable results with parallel processing capability. Diagnostic biochips can be designed to screen multiple patient samples for different diseases simultaneously. After being processed according to standard protocols, the biochips are fed to specialized biochip readers for analysis.

Typical biochip readers adopt the configuration of a confocal fluorescence microscope. The light-emitting source consists of one or several ion lasers. The light-receiving mechanism contains an optical pickup unit consisting of a high-sensitivity detector, an optical filter, and a focusing mechanism with lenses and mirrors. The laser beams are focused on the biochip by the objective lens to excite the fluorophores. The resulting fluorescence from the biochip is collected by the objective lens, focused via a pinhole, passed through the filter, and registered by a photomultiplier tube (PMT). Two-dimensional fluorescence imaging is accomplished by using two galvanometer mirrors for scanning or by mounting the biochip on a motorized stage.

Disadvantageously, the combined effects of current biochip equipment and sample preparation make the DNA analysis procedure time-consuming and expensive. Therefore, it would be highly desirable and advantageous to remedy the foregoing and other deficiencies inherent in the prior art by the development of a low cost, portable DNA chip reader for biomedical research and drug discovery.

Accordingly, it is an objective of the present invention to provide improvement in optical readers for fluorescence detection.

Another object of the invention is to provide improvement specifically directed to fluorescence optical pickup units (FOPU).

Another object of the invention is the simplification of such pick-up units or heads by eliminating the need for an optical filter.

Still another object of the immediate invention is the provision of improved means for mounting multiple biochips on a rotating disc cartridge.

A further object of this invention is to provide a simplified fluorescence biochip reader that is light in weight, has no moving parts, and is portable.

Still another object of the invention is the provision of means and improvements that accomplish the foregoing while materially reducing the cost of a biochip reader.

The foregoing and further and more specific objects and advantages of the instant invention will become readily apparent, not only to one skilled in the art who reviews the present specification and drawings, but also to one who has an opportunity to take advantage of an embodiment thereof.

### SUMMARY OF THE INVENTION

In achieving the foregoing and further objects, one preferred embodiment of the present invention comprises a biochip reader for detecting, reading, and analyzing biological information from a solid substrate. In such an embodiment, a fluorescence optical pickup unit (FOPU) can include a means for providing excitation light, a focusing means for directing that light to the biochip, and a means of receiving light from the biochip. Ideally, the means for receiving light from the biochip can scatter fluorescence light and block excitation laser light.

Still more preferably, the biochip reader can include a motorized rotating stage driven by a sled motor and a rotating stage motor thereby enabling it to provide two-dimensional fluorescence imaging efficiently and rapidly.

In accordance with a more specific embodiment of a FOPU, radial scanning is effected by means of a mini-scanner incorporating one or more semiconductor lasers.

In accordance with another preferred embodiment, the number of components in the system is reduced by the incorporation of a color-tinted optical fiber.

In accordance with a still more specific embodiment of a fluorescence image detection system, a laser/detector array chip is used such that the reader will be light, portable, and free of any moving parts.

Under these basic arrangements, one will appreciate that biological media can be fluorescently imaged on a rotatable stage by first disposing the biological media on the rotatable stage, rotating the rotatable stage, providing excitation light to the biological media, detecting fluorescence emitted from the biological media, and converting fluorescence emitted from the biological media to electronic signals. With this, the biological media disposed on the rotatable stage can be fluorescently imaged by a detection of fluorescence emitted from the biological media and a conversion of that fluorescence to electronic signals.

In practice, the biological media can be disposed on a substrate to form a biochip, which can be a rectangular slide or a rotatable disk-shaped cartridge. Of course, the biochip will ideally by secured to the rotatable stage as by a central hub for the disk-shaped cartridge or by mini-clamps for rectangular slides. The biological media can be disposed in a predetermined pattern on the substrate. For example, the biological media can be disposed in multiple parallel arc lines on a generally rectangular substrate, such as a slide. Alternatively, the biological media can be disposed on a disk-shaped substrate in a plurality of concentric circles.

In preferred embodiments, the rotatable stage, a means for rotating the rotatable stage, a means for providing excitation light to the biological media, and a means for detecting fluorescence emitted from the biological media can be packaged into an integral system comprising a computer CD-ROM drive-receivable arrangement. With this, the system can be removed and replaced relative to, for example, the CD-ROM drive of a laptop computer.

One will appreciate that the foregoing discussion broadly outlines the more important features of the invention to enable a better understanding of the detailed description that follows and to instill a better appreciation of the inventors' contribution to the art. Before an embodiment of the invention is explained in detail, it must be made clear that the following details of construction, descriptions of geometry, and illustrations of inventive concepts are mere examples of the many possible manifestations of the invention.

### BRIEF DESCRIPTION OF THE DRAWINGS

In the accompanying drawings:

FIG. 1 is a schematic of a prior art biochip reader made by Hewlett Packard that was designed to read genechips made by Affymetrix;

FIG. 2 is a simplified schematic of a conventional prior art multi-beam biochip reader using three lasers and an X-Y stage;

FIG. 3 is a simplified schematic diagram that illustrates an embodiment of a FOPU constructed in accordance with the present invention;

FIG. 4 is a schematic diagram that illustrates another embodiment of a FOPU that employs a dichroic mirror for beam splitting;

FIG. 5 is a schematic diagram that illustrates yet another embodiment of an FOPU using two lasers and two detectors;

FIG. 6 is a basic diagram of a one-dimensional mini-scanner according to the prior art;

FIG. 7 is a diagram of a two-dimensional mini-scanner according to the prior art;

FIG. 8 is a simplified diagram illustrating still another embodiment of a FOPU using a mini-scanner incorporated with a semiconductor laser;

FIG. 9 is a composite view of a mini-scanner incorporating one or two semiconductor edge-emitting lasers;

FIG. 10 is a diagram of a design configuration of a biochip in which biological material is printed as a two-dimensional array and as a set of curves;

FIG. 11 is a schematic diagram illustrating multiple biochips mounted on a disk;

FIG. 12 is another schematic diagram illustrating multiple biochips mounted on a disk;

FIG. 13 is a block diagram of the embodiment of FIG. 3 wherein the fluorescence imaging equipment includes a rotating stage and sled motors;

FIG. 14 depicts the characteristics of 670-nm and 652-nm visible oxide-confined VCSELs;

FIG. 15 is a schematic diagram depicting a matrix-addressing architecture of a laser and detector array with a center VCSEL surrounded by an REPD in each cell;

FIG. 16 is a schematic diagram of a portable FOPU compatible with a CD-ROM drive of a laptop computer with a GaAs wafer integrating laser and detector arrays;

FIG. 17 is a schematic diagram of an 8×8 glass-based biochip array with each element having immobilized DNA probes on ITO glass;

FIG. 18 is a schematic diagram of a portable biochip reader with an 8×8 array PMT and an 8×8 VCSEL array emitting at 670 nm;

FIG. 19 is a schematic diagram of the optical detection principal of FIG. 18 using an optical filter to block scattering light; and

FIG. 20 is a schematic diagram of a 6×6 matrix-addressable laser array.

### DETAILED DESCRIPTION OF PREFERRED EMBODIMENTS

As is the case with many inventions, the present invention for the fluorescence imaging of biological media on a rotating stage is subject to a wide variety of embodiments. However, to ensure that one skilled in the art will be able to understand and, in appropriate cases, practice the present invention, certain preferred embodiments of the broader invention revealed herein are described below and shown in the accompanying drawing figures.

A preferred embodiment of the present invention essentially comprises a low cost, portable biochip reader with a miniaturized fluorescence optical pickup unit (FOPU). A preferred pathway to this miniaturization is a modified CD reader incorporating a laser/detector array, which thereby eliminates all moving parts. Current biochip readers, such as those made by the companies HP and GSI Lumonics, are bulky, slow (reading one chip at a time), and expensive (up to $80,000 per unit). One can reasonably anticipate that this invention will provide readers that are lightweight, portable, easy to operate, and capable of reading multiple chips with high accuracy and reliability. Desktop units could at this time conceivably be sold for less than $5,000, and hand-held readers could be sold for less than $1,000.

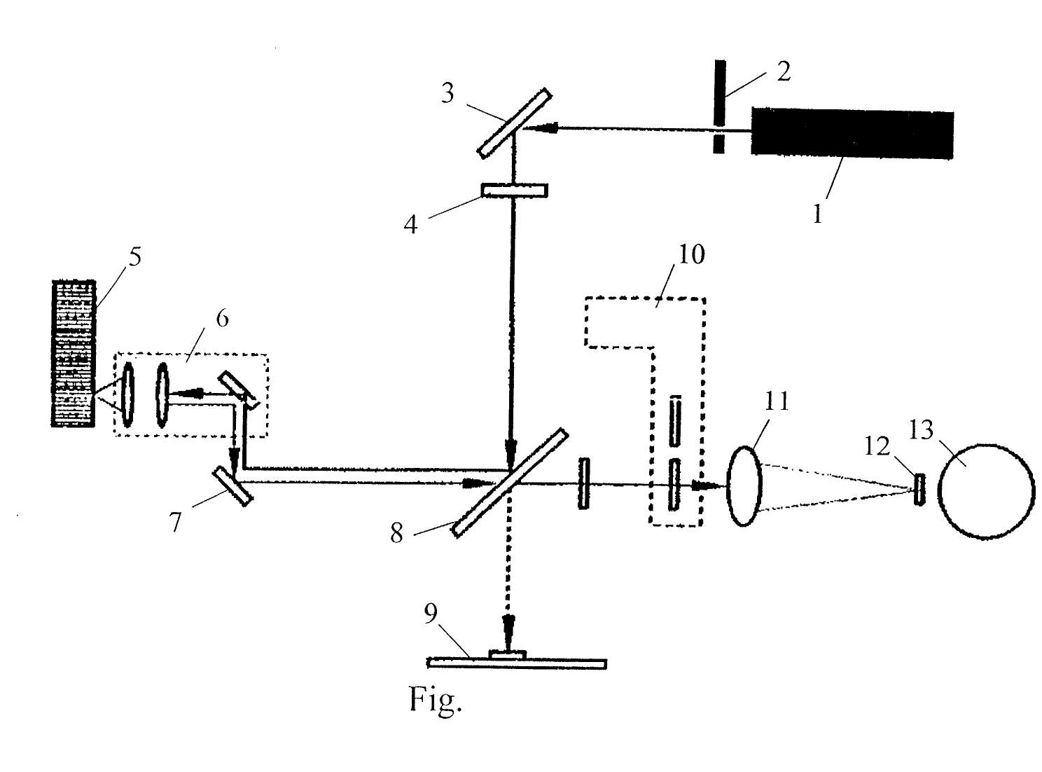

Most conventional readers are basically computer-controlled, inverted, confocal scanning microscopes with one, two, or three laser illumination systems. For example, FIG. 1 shows a conventional biochip scanner sold by the company Affymetrix. There, incident light from an argon ion laser 1 passes through an interference filter 4 and is then directed from a dichroic mirror 8 that is focused on the scanning head 6 via routing mirrors 3 and 7 and a confocal optical system. The chip cartridge 5 must be moved relative to the beam that excites the fluorophores. Spot size is approx. 8 μm. Fluorescent light passes back through the optical system including the dichroic mirror 8 to a set of filters 10 that allows only light of an appropriate wavelength to pass through. The remaining light is focused through an achromatic lens 11 and pinhole aperture 13 onto a PMT 12 that converts the fluorescent light into electrical current. The detector 9 monitors laser intensity. For two-dimensional scanning of the biochip, the scanning head must be moved horizontally while the chip holder is moved vertically.

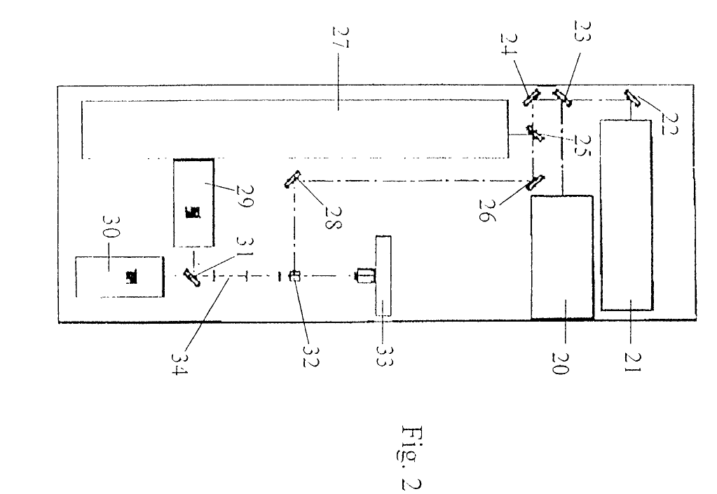

FIG. 2 depicts a prior art optical breadboard system. Illumination is from three air-cooled lasers: a 488 nm, 100 mw Argon ion laser 20 for exciting FITC; a 532 nm, 100 mw NdYag 14 for Cy3; and a 633 nm, 35 mw HeNe 13 for Cy5. Any two lasers can be turned on simultaneously and their beams combined by dichroic mirrors 16 and 18, aligned via mirrors 15, 17, 19, and 21, and delivered to the specimen on the stage 26 via a single dichroic 25 and an objective lens 27 (0.75NA, 0.66 mm wd). The objective lens can be focused with a digital controller. Emitted light, after passing back through the objective 27 and primary dichroic 25, is focused through a confocal pinhole 28 and through a secondary dichroic 24 onto two cooled PMT's 22 and 23 that operate in parallel for the two different wavelengths. The stage is a standard computer-controlled microscope X-Y stage capable of 100 mm/sec scans and 5 micron resolution. One or two standard 25×75 mm slides can be scanned at a time. Scanning is done in a comb pattern with data collected in both directions.

In contrast, the present invention describes a multi-functional, rotating disk-based, fluorescence detection system that is capable of reading various biological media on different solid substrates. In particular, preferred embodiments of the invention use semiconductor diode lasers and a rotating stage with circular-shaped disks. With this, the invention avoids the need for a much larger gas or ion laser system and an X-Y stage. Consequently, manufacturing costs of the reader will be substantially reduced.

As used herein, the definitions hereinafter set forth should be considered to apply. Biological media include, but are not limited to, DNA strands, RNA strands, proteins, antibodies, enzymes, toxins, viruses, and bacteria. Solid substrates include, but are not limited to, glass, polymer, quartz, plastics, gel, membranes, chips, and disks. Alternatives for lasers include any and all means capable of generating a light beam. Alternatives for biochips include any combinations of the aforementioned biological media on the aforementioned solid substrates. Alternatives for lenses, mirrors, optical fibers, and scanners include any optics equivalent in changing light beams and paths, which may, for example, collimate, diverge, and alter light directions. Alternatives for photomultiplier tubes (PMT) include any detection means capable of receiving optical signals and converting them to electronic signals.

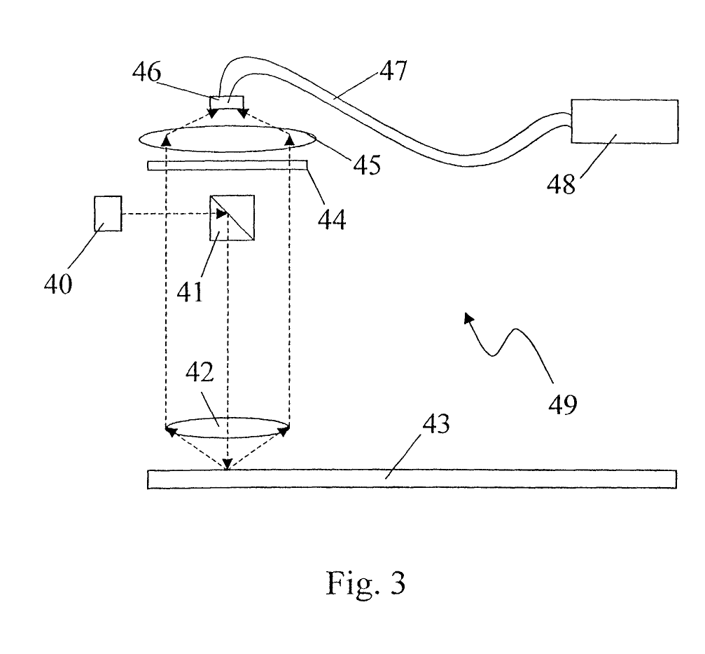

Looking to FIG. 3, one sees a preferred configuration of the fluorescence optical pickup unit (FOPU) 49 mounted on a motorized sled. Illumination from a semiconductor laser 40 is delivered to a biochip 43 via a reflective mirror 41 and a 0.6 NA CD objective lens 42. Fluorescence from the biochip, after passing back through the objective lens 42, an interference filter 44, and a collimating lens 45, is focused through a confocal pinhole 46 and an optical fiber 47 onto a PMT 48. The fluorescence is partially blocked by the small mirror 41.

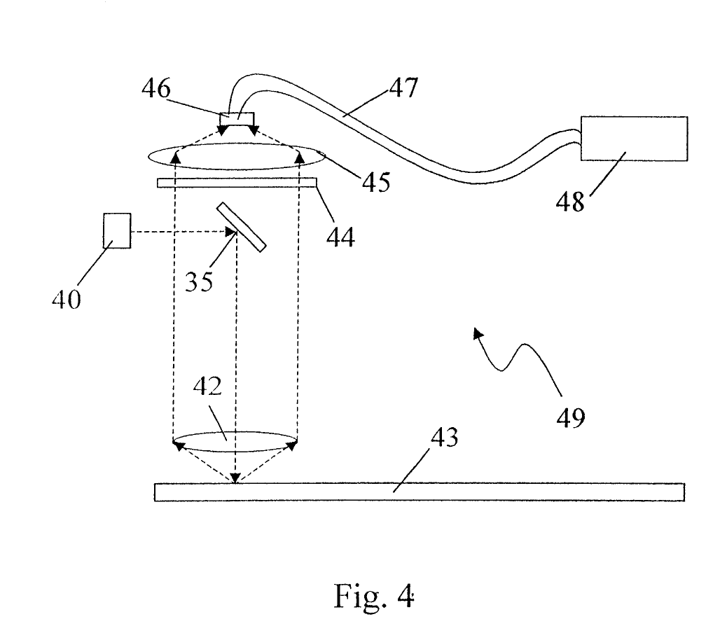

FIG. 4 shows the same configuration as FIG. 3, except that the reflective mirror 41 is replaced with a dichroic mirror 35. This alternatively preferred embodiment effectively blocks the reflected laser light, while concomitantly allowing only fluorescence light to pass through to the PMT 48. The preferred semiconductor laser 40 is a Vertical Cavity Surface-Emitting Laser (VCSEL).

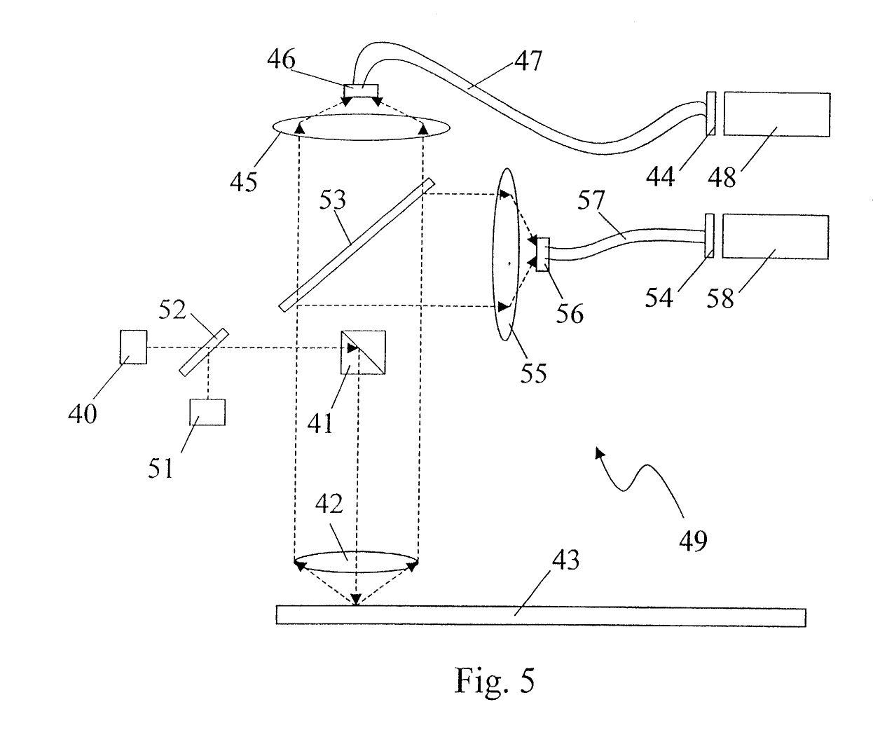

FIG. 5 shows a preferred dual-beam FOPU 49 design. Two lasers 40 and 51 are turned on simultaneously. Their beams are combined by a dichroic mirror 52 and delivered to the biochip 43 via the small mirror 41 and the objective lens 42. The fluorescence emitted from the biochip 43 passes through the objective lens 42 and is then separated into two beams of different wavelengths by another dichroic mirror 53. One beam is focused onto a PMT 48 via the collimating lens 45, a pinhole 46, a fiber 47, and a filter 44. The other beam is focused onto a PMT 58 via its collimating lens 55, pinhole 56, fiber 47, and filter 54.

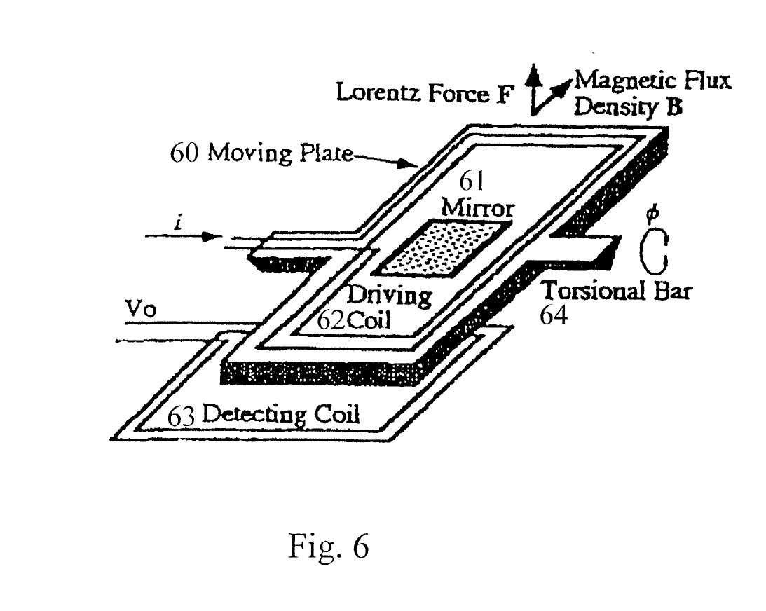

FIG. 6 shows a one-dimensional, silicon micro-machined, galvano-optical mini-scanner according to the prior art that can be incorporated into the FOPU. An aluminum driving coil 62 is fabricated on a moving plate 60 to control a reflecting mirror 61 electromagnetically. With the surface of the reflecting mirror 61 at the same level as its torsional bar 64, the reflecting point is stable. The reflecting mirror 61 will reach its maximum oscillation (detected by a coil 63) when the applied electromagnetic frequency is equal to its resonance frequency.

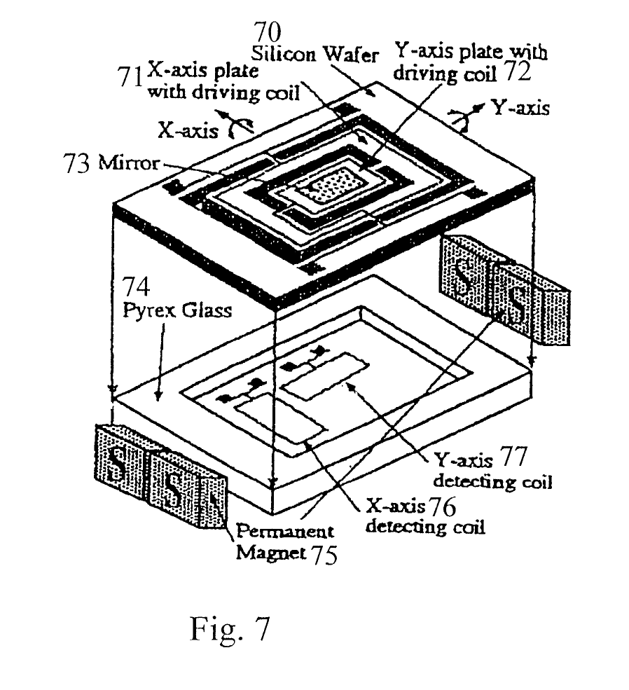

FIG. 7 shows a two-dimensional mini-scanner. Both X-axis 71 and Y-axis 72 plates with their independent driving coils are fabricated on the same silicon wafer 70, each having its own resonance oscillation frequencies monitored by coils 76 and 77 on PYREX glass 74. When current is applied to both driving coils between the permanent magnets 75, the mirror 73 oscillates in two dimensions. Mass production of such mini-scanners using micro-machining processes makes them much more cost-effective than conventional galvanometer scanners.

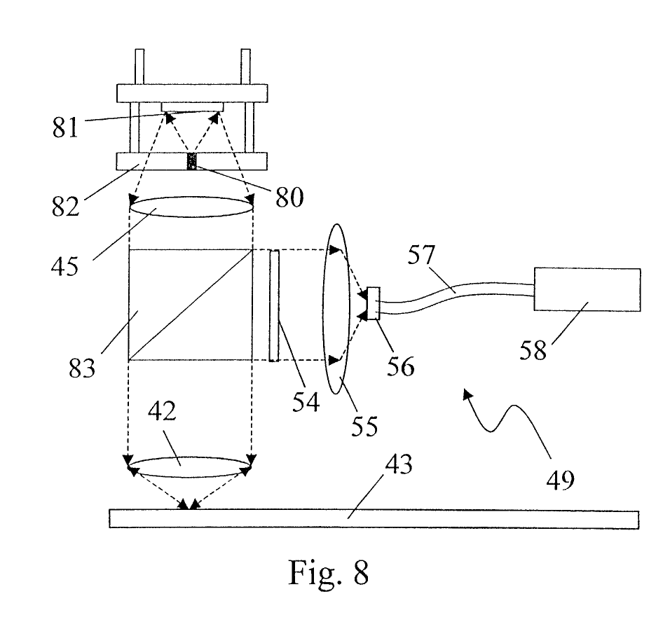

FIG. 8 shows a FOPU 49 design incorporating the mini-scanner. A laser 80 illuminates the scanning mirror 81. The reflected beam is directed to the biochip 43 via a glass window 82 on the mini-scanner, the collimating lens 45, a dichroic mirror 83, and the objective lens 42. Fluorescence from the biochip 43 passes through the objective lens 42 after which it is reflected by the dichroic mirror 83 through a filter 54 and focused by the collimating lens 55 to the pinhole 56 wherefrom the optical fiber 57 carries it to the PMT 58. Advantageously, both the sled motor and the moving stage can be eliminated because the mini-scanner can scan radially with respect to the rotating disk, which in this drawing is also indicated at 43, to cover all sample areas. To use the two-dimensional mini-scanner in the FOPU 49, the scanning area will be matched with sample areas on each biochip to generate 2-D images.

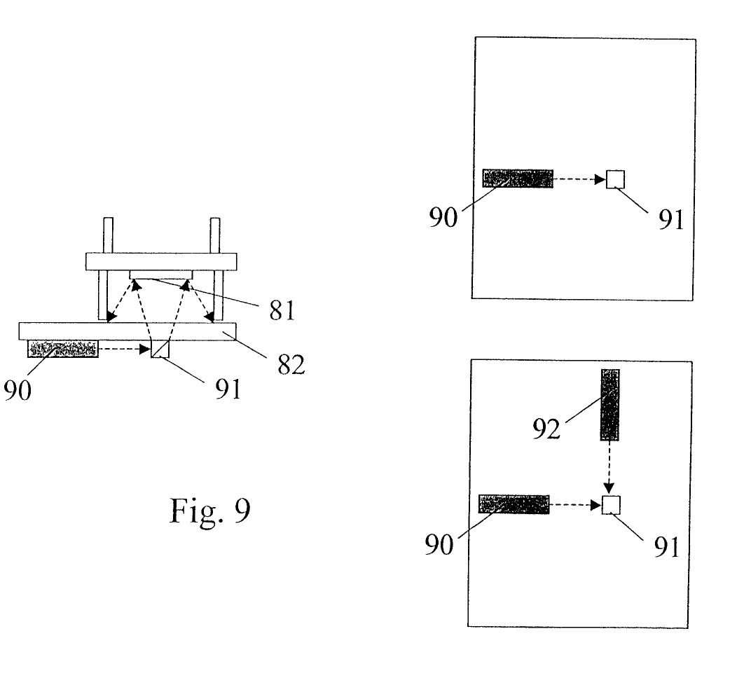

FIG. 9 shows an alternative to the preferred embodiment that employs an edge-emitting semiconductor laser 90 instead of a VCSEL as its excitation source. The beam from a laser 90 is reflected by a small mirror 91 onto the scanning mirror 81 via the glass window 81 of the mini-scanner. The dual-beam FOPU 49 uses two edge-emitting lasers 90 and 92 and a detection architecture identical to that in FIG. 5, where two PMTS 48 read two different signals.

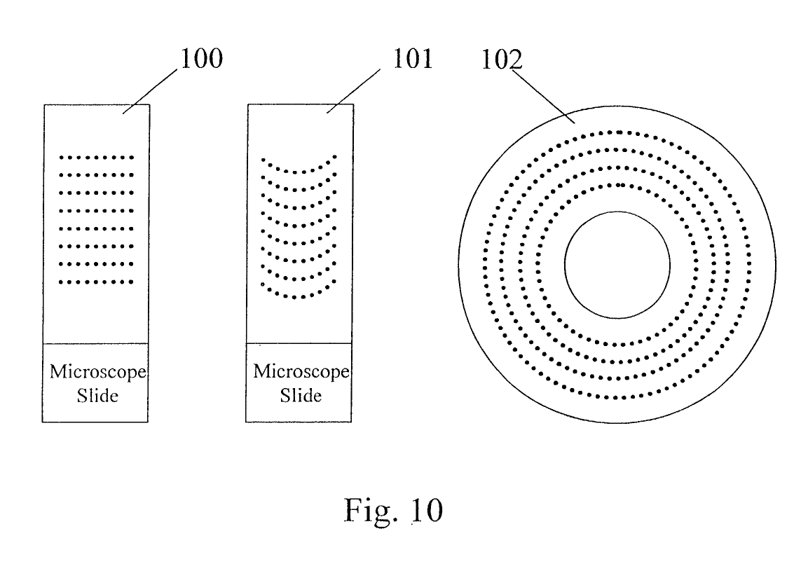

FIG. 10 shows preferred configurations of sample arrays. A two-dimensional array 100 deposited on a solid substrate such as a microscope slide is most conventional. Alternatives include multiple parallel arc lines 101 on a slide and concentric or spiral circles 102 on a glass or plastic disk substrate.

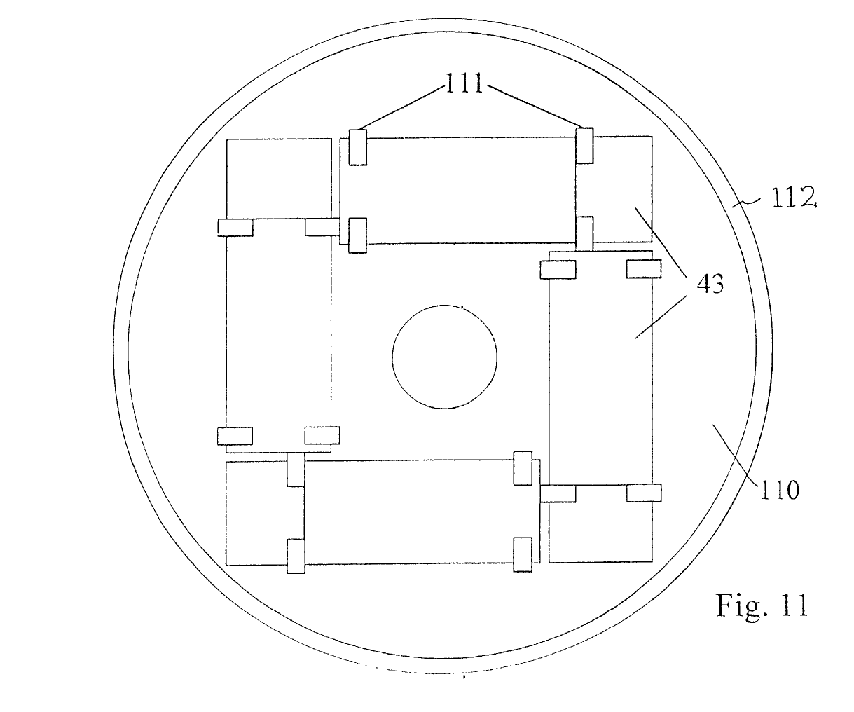

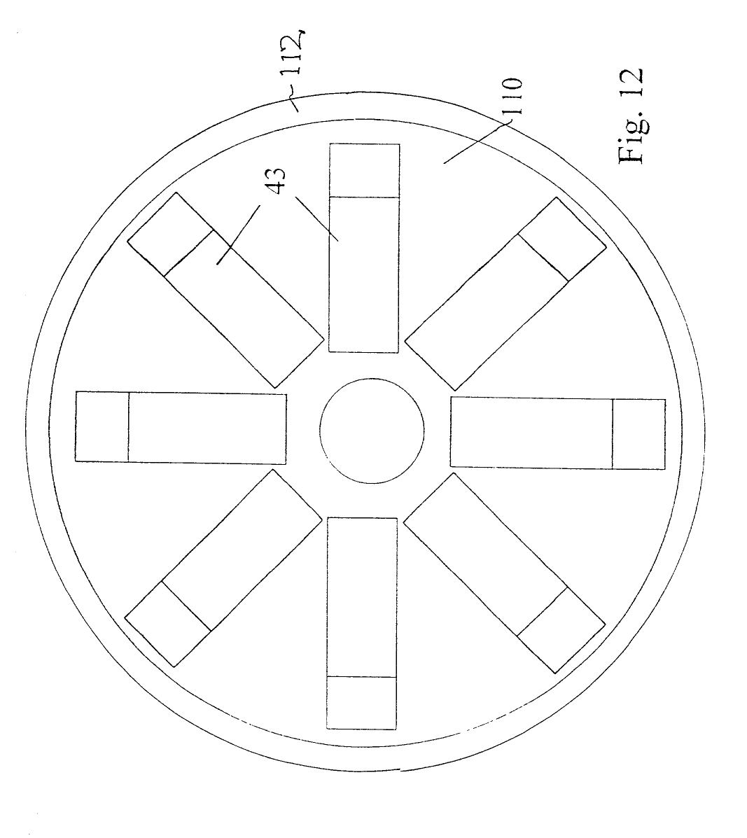

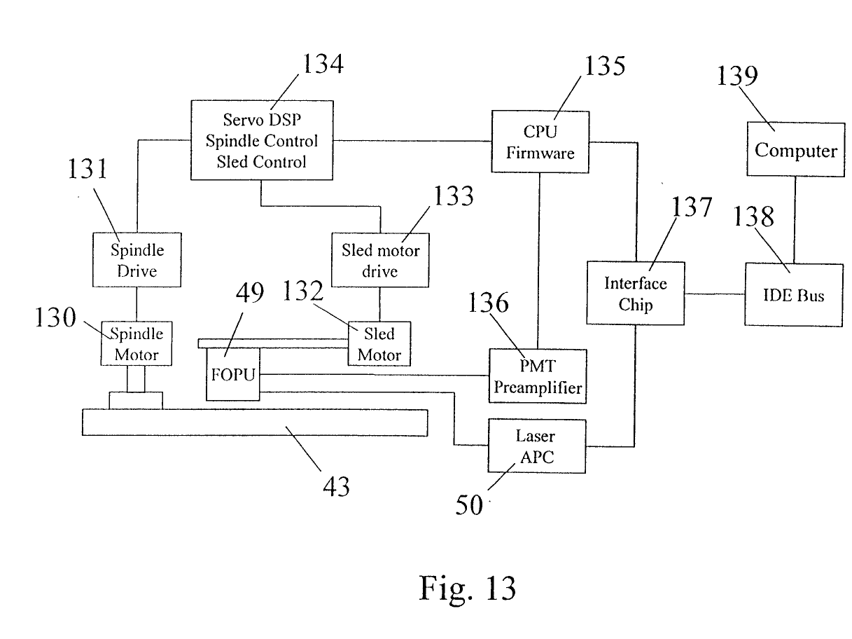

FIG. 11 shows a preferred configuration for mounting multiple (4 in particular) biochips 43 onto a disk cartridge 110, which in this case comprises a rotatable disk 110. Of course, while the invention is in imaging operation, the rotatable disk 110 can be considered a rotating disk 110. The biochips 43 are anchored onto the disk cartridge 110 with mini-clamps 111. The disk cartridge 110 is then put on a rotatable stage 112, which can be termed a rotating stage 112 when the invention is in operation. The rotatable stage 112 is driven by a spindle motor, which is indicated at 130 in FIG. 13, for fluorescence imaging. It will be evident that alternatives means for retaining the biochips 43 on the disk cartridge 110 include, but are not limited to, four-walled barriers, embedded slots, adhesives, and spring-clamps. Furthermore, FIG. 12 shows an alternative configuration to mount multiple (8 in particular) biochips 43 onto a disk cartridge 110. It will also be apparent that alternative layouts of the biochips 43 on the cartridge 110 are well within the scope of the present invention but are too numerous to detail individually.

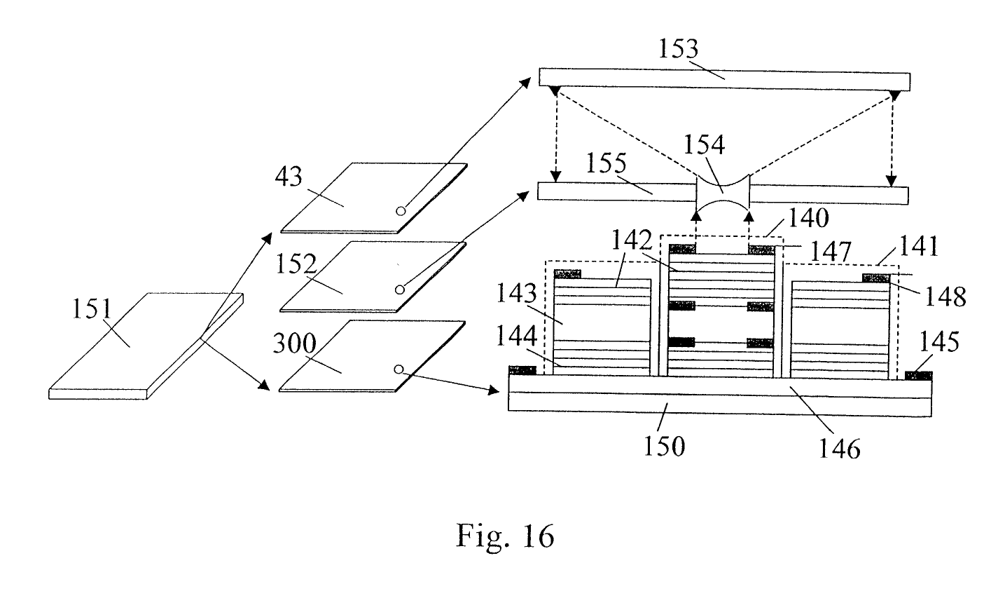

By locating the biochips 43 on the disk cartridge 110 and the rotating stage 112, the invention achieves significant advantages over prior art biochip readers. For example, under the aforedescribed arrangement, the system of the present invention can rotated and read samples of biological media much like a CD player reads from a CD. Indeed, as FIG. 16, which will be discussed in greater detail below, schematically shows, the system can be integrated into a CD-ROM drive-sized and receivable FOPU 151 that can actually be removably and replacably inserted into the CD-ROM drive of, for example, a laptop computer. With this, the invention can achieve heretofore-unrealized portability and convenience.

Most importantly, however, the FOPU, whether in its basic form 49 or in an integral structure 151, achieves functional advantages not achievable under prior art structures and methods. By employing a rotating stage 112 for rotating the biochips 143, the system markedly accelerates the scanning procedure. As one skilled in the art will be aware, during the scanning of a biochip 43, two-directional movement should proceed much faster along what may be termed a fast axis than along what may be termed a slow axis, which is generally perpendicular to the fast axis. When two linear movements carry out scanning, both are made in an oscillating manner. With this, the required rapid movement along the fast axis exacts significant mechanical load on the system and limits total scanning time. As a result, minimum total scanning time for a single spotted microarray on a microscope slide in prior art biochip readers is a number of minutes for good spatial resolution.

However, under the present invention, the present system locates the fast axis generally along what may be considered arcuate tracks on the rotating stage 112, the disk-shaped cartridge 110, and the biochips 43. By way of example as FIG. 10 shows, the tracks could be along circumferences of concentric circles on the rotating stage 112, the disk-shaped cartridge 110, and the biochips 43. Alternatively, there could be just a single track disposed in a spiral configuration. The slow axis advantageously communicates radially relative to the rotating stage 112. As a result, movement along the fast axis is at a generally constant velocity as compared to the oscillating action of the prior art whereby the present invention can proceed much faster. Under present estimations with rotation speed assumed to be roughly equivalent to that of current CD-ROM drives, the total scanning time for a glass microslide can be as little as 10 seconds.

A further advantage of the present invention derives from the fact that the length of the fast axis depends proportionally on the radius of the disk-shaped cartridge 110. With this, a relatively long effective fast axis can be achieved whereby significant areas or amounts of biological media can be read simultaneously. For example, as FIGS. 11 and 12 show, several biochips 43 can be retained and scanned on the disk-shaped cartridge 110 and the rotating stage 112 simultaneously. The relatively long effective fast axis can also allow for multiple optical heads (not shown) to be spaced over the rotating stage 112 to provide simultaneous, multi-color fluorescence excitation and scanning.

FIG. 13 shows a preferred detection system in which the FOPU 49 is mounted on a motorized sled 132. For two-dimensional fluorescence imaging, the biochip 43 is rotated at constant angular velocity (CAV) or constant linear velocity (CLV) with the FOPU 49 moving radially. A CPU firmware 135 commands a servo DSP 134, which controls the spindle motor 130 and the sled motor 132 via a spindle drive 130 and a sled motor drive 133 respectively. The CPU firmware 135 feeds the data from the servo 134 and the PMT preamplifier (fluorescence signals) back to a computer 139 through an interface chip 137 and an IDE bus 138. The computer 139 records the signals from the PMT preamplifier, regulates the laser intensity via a laser APC 50, and sends new instructions to the firmware 135.

Yet another potential refinement of the invention relates to the elimination of the optical filter 54. Its role is to keep laser excitation light from reaching the detector and to allow only florescence light to pass through. By adding dye to the glass mixture before the fiber is extruded (with dye concentration determined by fiber length), the filtering capability can be co-opted onto the optical fiber.

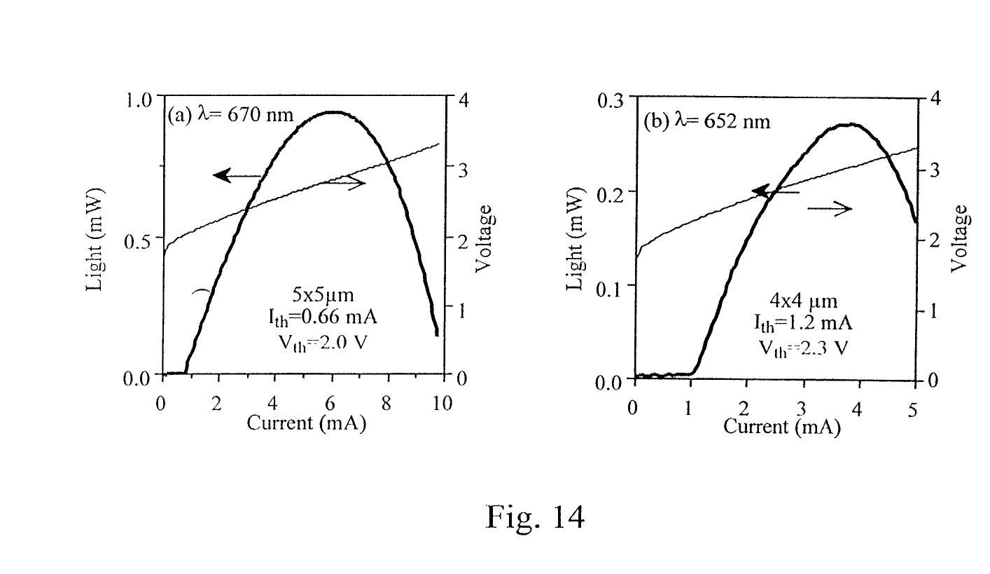

FIG. 14 represents characteristics of oxide-confined red VCSELs. VCSELs have a circular beam shape and wafer normal emission. They can be tested on-wafer, manufactured in high volumes, and fabricated in 2-dimensional arrays. State-of-the-art visible-light VCSELs have low threshold currents (250 μA), low threshold voltages (1.98 V), high power conversion efficiency (50%), and high output power (8 mW). These characteristics are considered crucial for low-power battery operation.

A variety of photodetectors have been developed that use III-V semiconductors, including metal/semiconductor/metal (MSM), resonant cavity photodetectors (REPD), and a separate amplifying medium (SAM). MSM detectors are simplest in design, but may prove difficult to fabricate in a matrix-addressable structure. Also, SAM detectors are still more difficult to fabricate. With this, REPD for the FOPU 49 are preferred.

Because optimum VCSEL performance calls for a resonance cavity with high mirror reflectivity while an REPD requires a resonance cavity with lower reflectivity, it is necessary to have the VCSEL and REPD share a common, multiple quantum-well active region, but embedded in separate resonance cavities. In this case, the REPD's cavity will be embedded within the cavity of the VCSEL so that the REPD's cavity can be engineered by chemically removing some of the AlAs/AlGaAs quarter-wave layers from the top DBR mirror. The number of quarter-wave layers in the bottom DBR mirror will then be chosen on the basis of optimum performance for the VCSEL and the REPD. It has been demonstrated recently that detector efficiencies for monolithically integrated InGaAs VCSEL/REPD devices can reach as high as 85%, which is much higher than for PMT and APD detectors. The REPD detector is ideal for low-level fluorescence detection in this application.

Electrical connection to the laser elements is also of major importance in the fabrication of high-density, two-dimensional VCSEL arrays. Lasers in the array can be turned on independently by means of individual addressing or matrix addressing. For an N×N array, independent addressing requires N² connections, which quickly becomes unfeasible for N>10. The insertion of this many connections renders closely pitched arrays impossible. In contrast, matrix addressing needs only 2N contacts and thus is appropriate for the high-density (400×400) VCSEL arrays in the FOPU 49. The contacts are spaced conveniently about the periphery of the active device, thus occupying minimal space. One prior art inventor has designed, fabricated, and characterized a 32×32 matrix addressable VCSEL with fairly homogeneous characteristics by using chemically assisted reactive ion etching. Only 64 electrical contacts are needed to address 1024-element lasers individually.

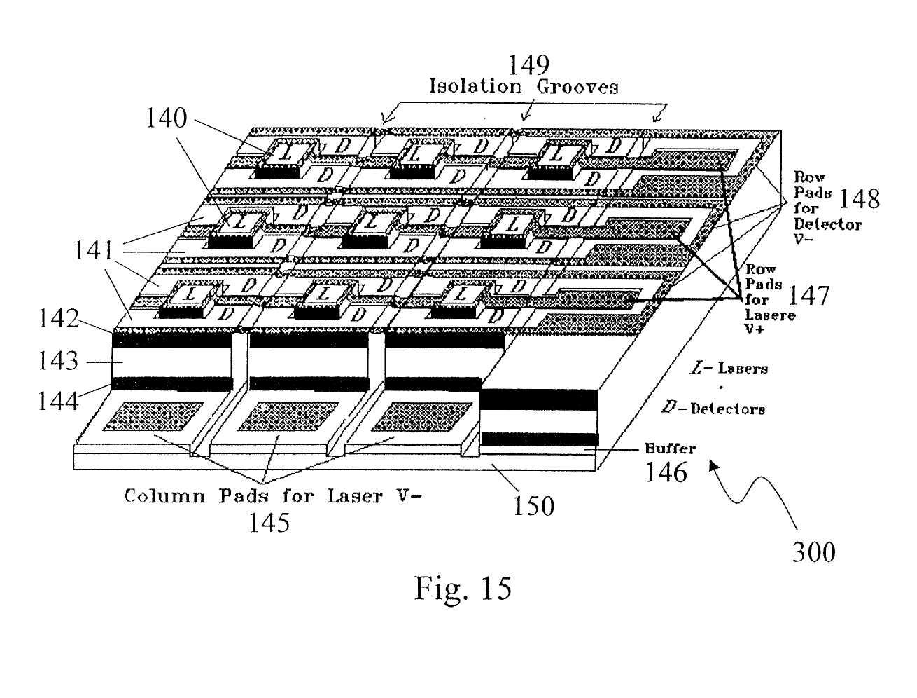

FIG. 15 shows a 3×3 matrix-addressable VCSEL/REPD array 300 designed according to the foregoing requirements and restraints. A buffer layer 146 is grown between a substrate 150 and the laser 140/detector 141 structures to serve as the n contact layer 145. The active region 143 consists of either GaInP/AlGaInP or GaAs/AlGaAs quantum wells. The epitaxial mirror structures are composed of alternating AlAs/GaAs 1/4 layers. The bottom mirrors 144 are n-doped Si, and the top mirrors 142 are p-doped Be. All the lasers 140 and detectors 141 in a row are electrically connected via their common n+ epitaxial row pads 147 and 148, respectively, with all the p contacts shorted. Each column is isolated from one another by ion-etched grooves (149). With all other contacts open, when a voltage is applied between a specific row and a specific column, the only activated element is that laser 140 or detector 141 in the prescribed row-column intersection.

FIG. 16 shows a preferred FOPU configuration 49 employing the VCSEL/REPD array 300. Matrix-addressable (hence programmable) arrays of VCSELs 140 (9642-680 nm or 700-990 nm wavelength) and REPDs 141 are fabricated on a gallium-arsenide wafer 150. Each element of the laser 140 and its surrounding confocal detector 141 can be simultaneously turned on and off. The VCSEL/REPD array 300 is aligned confocally with the biochip 43 and lens/filter array 152. Confocal imaging will reject any extraneous light. A lens 154 is used to diverge the beam from the laser 140 onto the target 153. A filter 155 in front of the detector 141 blocks reflected light from the target 153.

Under this arrangement, the biochip 43, the lens/filter array 152 and the VCSEL/REPD array can be packaged together into a CD-ROM drive-sized and receivable FOPU 151. Since there are no moving parts in this configuration, fluorescence imaging achieved by electrically turning on/off the laser/detector can be very fast (up to 6000 frames per second). Advantageously, this makes it an ideal tool for monitoring hybridization and other molecular bindings. With this, the FOPU 151 can be removed and replaced relative to a CD-ROM drive in, for example, a laptop computer. This embodiment features battery operation, the built-in planar microlens and filter 152, and the novel, matrix-addressable, visible-light VCSEL/detector array 300 for illumination and detection. Sequentially turning on and off the laser/detector pair at each matrix cell produces a high-contrast confocal laser-induced fluorescence image. Unlike conventional confocal biochip scanners, this design has no moving parts or bulky optics. It will provide an efficient, high-throughput, fast-imaging instrument that is compact and versatile enough for the repeated sequence analyses in both clinical and research laboratories.

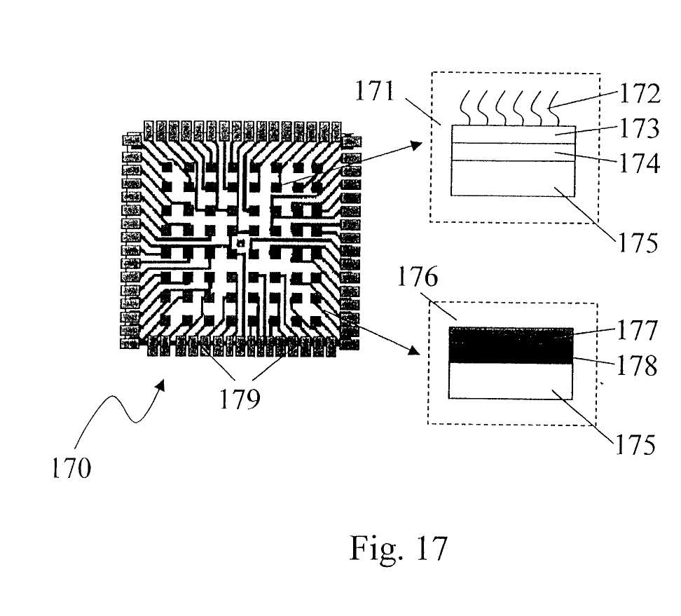

FIG. 17 illustrates yet another biochip embodiment. There, one sees an 8×8 DNA probe array chip 170 containing specific fluorophore-labeled oligonucleotide sequences 172 immobilized on a glass chip 175 coated with ITO 174 and cross-linker 173. An electric field is applied to each probe cell 171 via bonding pads 179 and embedded wire strips 176 with platinum 178 and insulator 177 to accelerate probe-sample hybridization, and to wash away single strands.

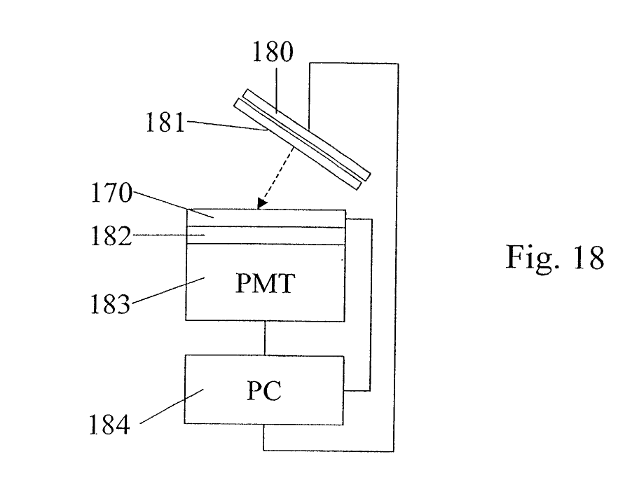

FIG. 18 shows the FOPU schematics to read the probe array chip 170. An 8×8 photomultiplier tube (PMT) 183 or an avalanche photodetector (APD) array is placed underneath the probe array chip 170 with a bandpass filter sandwiched in between. This enables detection of almost 50% of the fluorescence intensity and real-time monitoring of the hybridization process. An 8×8 VCSEL array 180 is optically aligned relative to the probe chip 170 and the detector array 183 via a micro-lens array 181. A computer 184 controls the hybridization on the probe chip 170 and records fluorescence signals from the detector 183.

Sequentially turning on and off each laser and its corresponding detector will result in a high-contrast image of the hybridized probe array. Since the PMT 183 has almost one hundred times the quantum efficiency of any charge-coupled device (CCD) detectors, this embodiment will have very high sensitivity. If molecular beacons are used, the hybridization process can be monitored in real-time because only exactly matched DNA pairs will fluoresce while unmatched pairs will not. Furthermore, the chemical washing step normally required in the hybridization process can be eliminated.

In FIG. 18, the microlens array 181 is placed in front of the laser array 180 to ensure that the collimated laser beams are aimed at the probe array 170. Since the laser array 180 is aligned at an angle with respect to the probe array 170, the pitch between different rows of laser diodes should be different: d_{column}=d_{row}/ sin α), where α is the angle between the laser array 180 and probe array 170. In this way, every laser in the laser array 180 will be accurately aligned with its corresponding cell on the probe array 170.

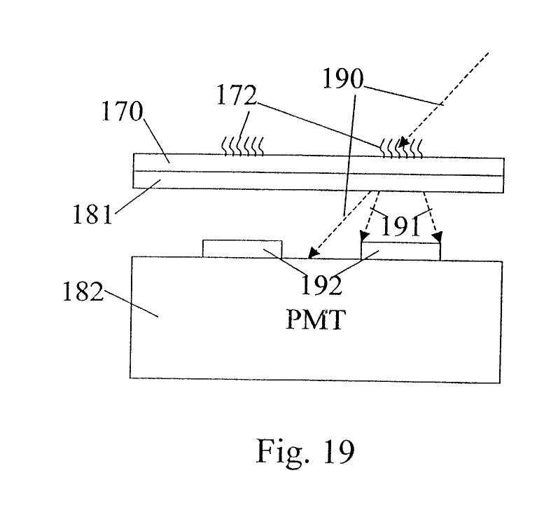

FIG. 19 shows the detailed optical path of the FOPU in FIG. 18. The intensity of fluorescence light is about 10⁻⁷ times or even less that of excitation light. However, even the best optical filters can filter out only 10⁻³ of the excitation light. To prevent the detector 182 from registering the excitation laser light 190, the laser beam 190 is aligned at an angle with respect to the probe array 170 surface. This way, only fluorescence 191 from the probes 172 passes the filter 181 and reaches the corresponding detector cells 192. Since only one laser, with its corresponding detector cell 192 are turned on at any one time, the excitation light 190 will not reach the active detector cell 192. The filter 181 also blocks scattering laser light.

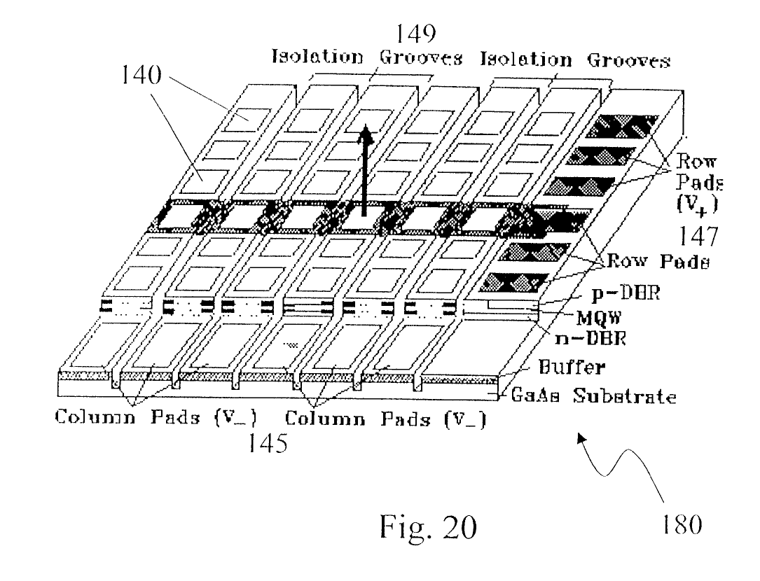

FIG. 20 shows an example of a 6×6 matrix-addressable VCSEL array chip 180 as the fluorescence excitation source for the probe array chip (170). In a highly efficient fashion, the array employs a common contact for each row and column. Any individual laser 140 in the matrix, while electrically isolated from each other, can be accessed. Each column pad electrically connects all the lasers 140 in a column, while each row pad connects all lasers 140 in a row. The array column is defined by deep, ion-etched isolation grooves 149. Selective oxidation forms a laser aperture under a top-mounted Bragg reflector mirror. In each row, all the p contacts of the lasers 140 are shorted. By applying voltage in between a specific row and a specific column while keeping all the other contacts open, the only closed current path is through the laser 140 at the prescribed row-column intersection.

In considering the aforedescribed embodiments of the invention, it will be appreciated by one skilled in the art that numerous changes and additions could be made thereto without deviating from the spirit or scope of the invention. This is particularly true when one bears in mind that the presently preferred embodiments merely exemplify the broader invention revealed herein.

Accordingly, it will be clear that those with major features of the invention in mind could craft embodiments that incorporate those major features while not incorporating all of the features included in the preferred embodiments. Therefore, the following claims are intended to define the scope of protection to be afforded the inventors. Those claims shall be deemed to include equivalent constructions insofar as they do not depart from the spirit and scope of the invention.

It must be further noted that a plurality of the following claims express certain elements as means for performing a specific function, at times without the recital of structure or material. As the law demands, these claims shall be construed to cover not only the corresponding structure and material expressly described in this specification but also equivalents thereof.

We claim as deserving the protection of Letters Patent:

1. A system for the fluorescence imaging of biological media on a rotatable stage, the system comprising:
a rotatable stage for retaining biological media;
a means for rotating the rotatable stage; and
a fluorescence optical pickup unit for reading fluorescence images of biological media, the fluorescence optical pickup unit comprising:
a means for providing excitation light to the biological media;
a means for detecting fluorescence emitted from the biological media; and
a means for converting fluorescence emitted from the biological media to signals;
whereby biological media retained relative to the rotatable stage can be fluorescently imaged during a rotation of the rotatable stage by a detection of fluorescence emitted from the biological media and a conversion of that fluorescence to signals.

2. The system of claim 1 further comprising a rotatable member for being disposed on the rotatable stage.

3. The system of claim 2 further comprising a means for retaining biological media relative to the rotatable member.

4. The system of claim 3 wherein the means for retaining biological media relative to the rotatable member comprises at least one biochip.

5. The system of claim 4 wherein the means for retaining biological media relative to the rotatable member further comprises a means for retaining the at least one biochip on the rotatable member.

6. The system of claim 5 wherein the means for retaining the at least one biochip on the rotatable member comprises at least one mini-clamp.

7. The system of claim 1 further comprising at least one biochip for being rotated by the rotatable stage wherein the at least one biochip comprises a substrate with biological media disposed in a pattern thereon.

8. The system of claim 7 wherein the pattern in which the biological media is disposed on the substrate comprises multiple parallel arc lines.

9. The system of claim 8 wherein the substrate is generally rectangular.

10. The system of claim 7 wherein the pattern in which the biological media is disposed on the substrate comprises a plurality of concentric circles.

11. The system of claim 10 wherein the substrate is disk shaped.

12. The system of claim 1 wherein the means for rotating the rotatable stage comprises a spindle motor.

13. The system of claim 12 wherein the means for rotating the rotatable stage further comprises a spindle drive.

14. The system of claim 1 wherein the system is packaged into a computer CD-ROM drive-receivable arrangement.

15. The system of claim 14 wherein the system can be removed and replacably inserted into a computer CD-ROM drive.

16. The system of claim 14 wherein the means for providing excitation light to the biological media comprises a plurality of VCSELS, wherein the means for detecting fluorescence emitted from the biological media comprises a plurality of detectors, and wherein the plurality of VCSELS and detectors are disposed in a single array whereby the fluorescence optical pickup unit can operate without moving parts.

17. The system of claim 16 wherein the array of the plurality of VCSELS and the plurality of detectors comprises a matrix-addressable array.

18. The system of claim 17 wherein the array comprises a VCSEL/REPD array.

19. The system of claim 1 further comprising a mini-scanner interposed along an optical path between the means for providing excitation light and the biological media for scanning excitation light over the biological media.

20. The system of claim 1 further comprising an interference filter and a collimating lens interposed along an optical path between the biological media and the means for detecting fluorescence emitted from the biological media.

21. The system of claim 1 further comprising a means for blocking reflected laser light from reaching the means for detecting fluorescence emitted from the biological media while allowing fluorescence emitted from the biological media to reach the means for detecting fluorescence emitted from the biological media.

22. The system of claim 21 wherein the means for blocking reflected laser light from reaching the means for detecting fluorescence emitted from the biological media while allowing fluorescence emitted from the biological media to reach the means for detecting fluorescence emitted from the biological media comprises a dichroic mirror.

23. The system of claim 1 further comprising a second means for providing excitation light to the biological media, a means for directing light provided by the second means for providing excitation light toward the biological media, and a means for focusing the excitation light provided by the second means for providing excitation light on the biological media.

24. The system of claim 23 further comprising a means for separating fluorescence from the biological media into fluorescence of different wavelengths.

25. The system of claim 24 wherein the means for separating fluorescence from the biological media into fluorescence of different wavelengths comprises a dichroic mirror.

26. A method for the fluorescence imaging of biological media on a rotatable stage comprising the steps of:
disposing biological media on a rotatable stage;
rotating the rotatable stage;
providing excitation light to the biological media;
detecting fluorescence emitted from the biological media; and
converting fluorescence emitted from the biological media to signals;
whereby biological media disposed on the rotatable stage can be fluorescently imaged by a detection of fluorescence emitted from the biological media and a conversion of that fluorescence to signals during a rotation of the rotatable stage.

27. The method of claim 26 wherein the step of disposing the biological media on the rotatable stage comprises disposing the biological media on a rotatable member and disposing the rotatable member on the rotatable stage.

28. The method of claim 27 wherein the step of disposing the biological media on the rotatable stage further comprises disposing the biological media on at least one biochip and securing the at least one biochip on the rotatable member.

29. The method of claim 26 wherein the step of disposing the biological media on the rotatable stage comprises disposing the biological media on a substrate in a pattern to form a biochip and securing the biochip relative to the rotatable stage.

30. The method of claim 29 wherein the step of disposing the biological media on the substrate in a pattern comprises disposing the biological media on a generally rectangular substrate in multiple parallel arc lines.

31. The method of claim 29 wherein the step of disposing the biological media on the substrate in a pattern comprises disposing the biological media on a disk-shaped substrate in a plurality of concentric circles.

32. The method of claim 26 further comprising the step of packaging the rotatable stage, a means for rotating the rotatable stage, a means for providing excitation light to the biological media, and a means for detecting fluorescence emitted from the biological media into a system comprising a computer CD-ROM drive-receivable arrangement.

33. The system of claim 32 wherein the step of packaging the rotatable stage, the means for rotating the rotatable stage, the means for providing excitation light to the biological media, and the means for detecting fluorescence emitted from the biological media into the system comprising the computer CD-ROM drive receivable arrangement further comprises packaging the system into an arrangement that can be removed and replacably inserted into a computer CD-ROM drive.

34. The method of claim 32 wherein the step of providing the means for providing excitation light to the biological media comprises providing a plurality of VCSELS and wherein the step of providing the means for detecting fluorescence emitted from the biological media comprises providing a plurality of detectors

35. The method of claim 34 further comprising the step of disposing the plurality of VCSELS and detectors in a single array whereby the system can operate without moving parts.

36. The method of claim 35 wherein the step of disposing the plurality of VCSELS and detectors in the single array comprises disposing the VCSELS and detectors in a matrix-addressable VCSEL/REPD array.

37. The method of claim 26 further comprising interposing a mini-scanner along an optical path between the biological media and a means for providing excitation light for scanning excitation light over the biological media.
